(19) United States
(12) Patent Application Publication
(10) Pub. No.: US 2009/0188995 A1
(43) Pub. Date: Jul. 30, 2009

(54) FAUCET APPARATUS

(75) Inventors: Naoyuki ONODERA, Fukuoka (JP); Tomoko Sato, Fukuoka (JP); Masahiro Kuroishi, Fukuoka (JP); Makoto Hatakeyama, Fukuoka (JP); Takeshi Shimizu, Fukuoka (JP)

Correspondence Address: KIMBLE INTELLECTUAL PROPERTY LAW, PLLC, 1701 PENNSYLVANIA AVE., NW, SUITE 300, WASHINGTON, DC, 20006, US

(73) Assignee: TOTO LTD., Fukuoka (JP)

(21) Appl. No.: 12/277,347

(22) Filed: Nov. 25, 2008

Related U.S. Application Data
(60) Provisional application No. 60/991,221, filed on Nov. 30, 2007.

(51) Int. Cl. B05B 1/34; F03B 13/10

(52) U.S. Cl. 239/383; 290/54

(57) ABSTRACT

A faucet apparatus includes: a rotatable rotor vane which is disposed in a water supply channel, and in which an axial direction is substantially parallel to the water supply channel; a magnet which is rotatable integrally with the rotor vane; a coil which is disposed to be opposed to one end face in an axial direction of the magnet; and a controller which is disposed on a side of the one end face of the magnet and above the water supply channel, and which is connected to the coil through wiring.

This application claims the benefit of U.S. Provisional Application No. 60/991,221, filed Nov. 30, 2007. This disclosure of the application is incorporated herein in their entirety by reference.

### TECHNICAL FIELD

The present invention relates to a faucet apparatus including a generator which generates electricity by using a flow of water supply.

### RELATED ART

Conventionally, an automatic faucet apparatus has been known in which, when a hand is introduced under a tap, a sensor senses the hand, and water is automatically discharged from the tap. Also an apparatus has been known in which a small generator is disposed in a channel of such an automatic faucet apparatus, an electric power obtained by the generator is stored, and the stored power is supplied additionally to a circuit such as the sensor.

For example, Patent Reference 1 discloses an axial automatic faucet generator having a configuration where a coil and a yoke are disposed on the downstream side in the axial direction of a magnet. In the configuration, when a controller is disposed on the upstream side of the magnet, wiring for outputting electricity generated in the coil must be laid beyond the magnet in order to reach the controller. Therefore, the assembly step is very complicated. In the case where the controller is not disposed above a channel, when dew condensation occurs in a channel piping, there arises a fear that the controller is submerged.

[Patent Reference 1] JP-A-2004-336982

### SUMMARY

The present invention provides a faucet apparatus in which the arrangement relationships of incorporated components are improved.

According to an aspect of the invention, a faucet apparatus is provided wherein the faucet apparatus comprises: a rotatable rotor vane which is disposed in a water supply channel, and in which an axial direction is substantially parallel to the water supply channel; a magnet which is rotatable integrally with the rotor vane; a coil which is disposed to be opposed to one end face in an axial direction of the magnet; and a controller which is disposed on a side of the one end face of the magnet and above the water supply channel, and which is connected to the coil through wiring.

According to the invention, a faucet apparatus in which the arrangement relationships of incorporated components are improved is provided.

### BRIEF DESCRIPTION OF THE INVENTION

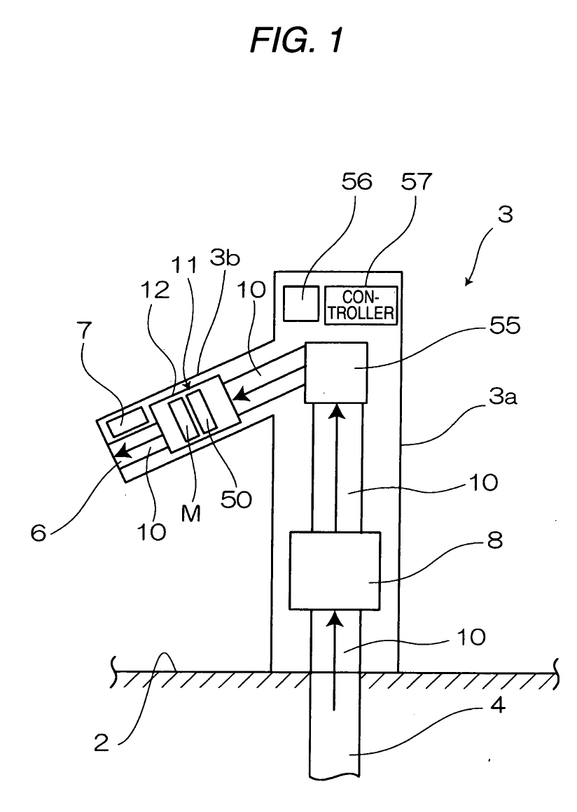

FIG. 1 is a schematic view showing the internal configuration of a faucet apparatus of a first embodiment.

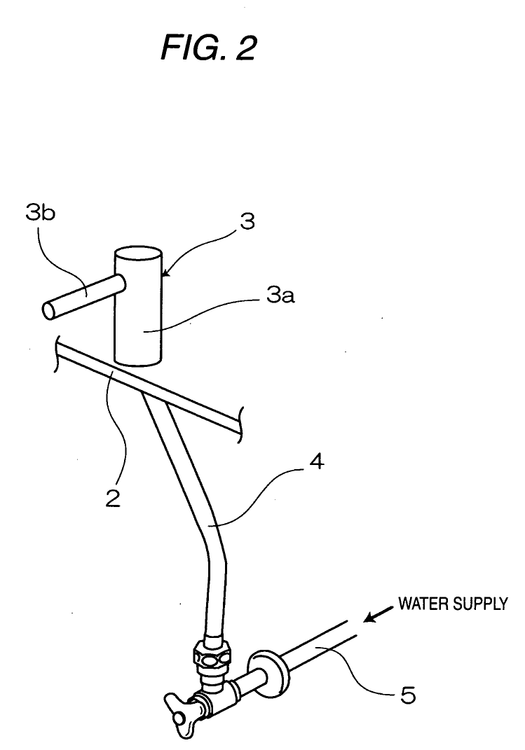

FIG. 2 is a schematic view showing an appearance of the faucet apparatus of the first embodiment and an example of mounting.

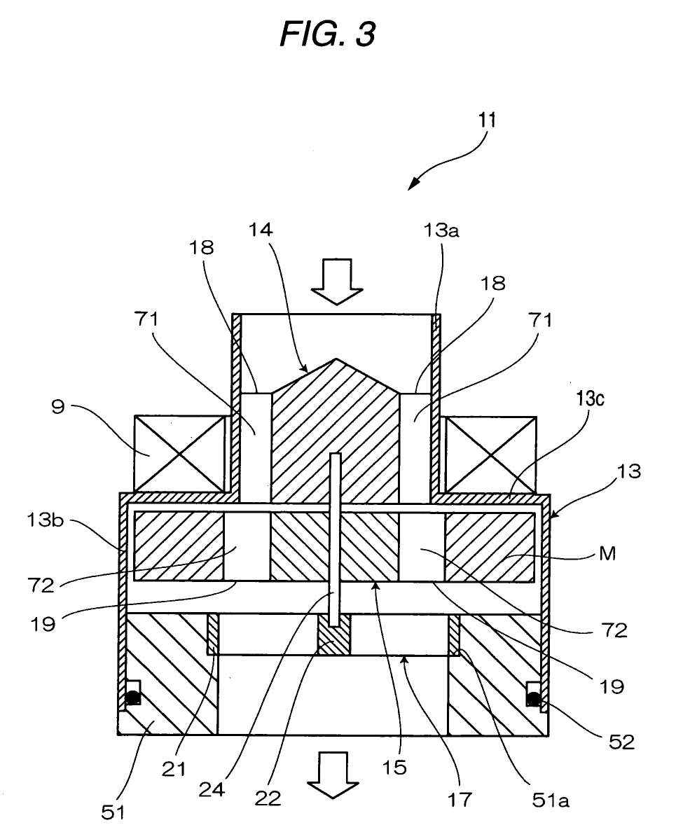

FIG. 3 is a schematic sectional view showing the interior of a faucet generator incorporated in the faucet apparatus of the first embodiment.

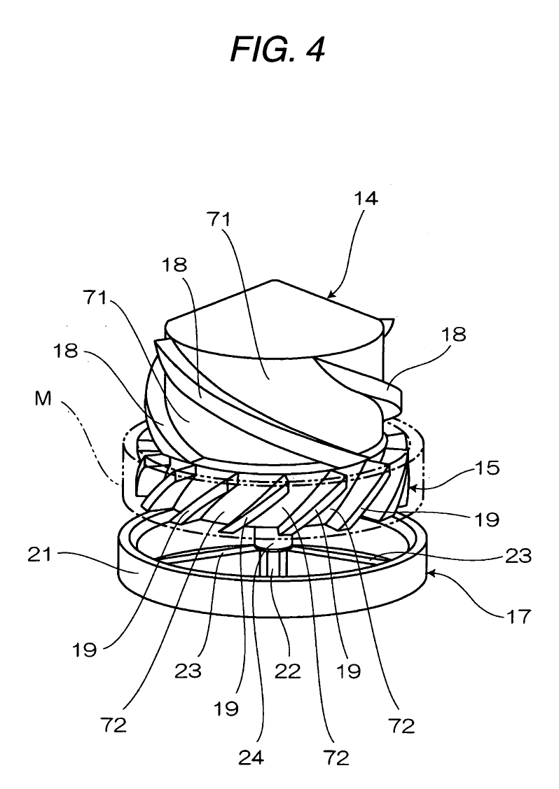

FIG. 4 is a perspective view of a pre-rotation stator vane, a rotor vane, and a bearing in the faucet generator shown in FIG. 3.

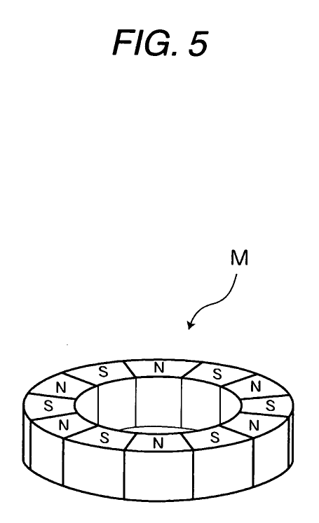

FIG. 5 is a perspective view of a magnet in the faucet generator shown in FIG. 3.

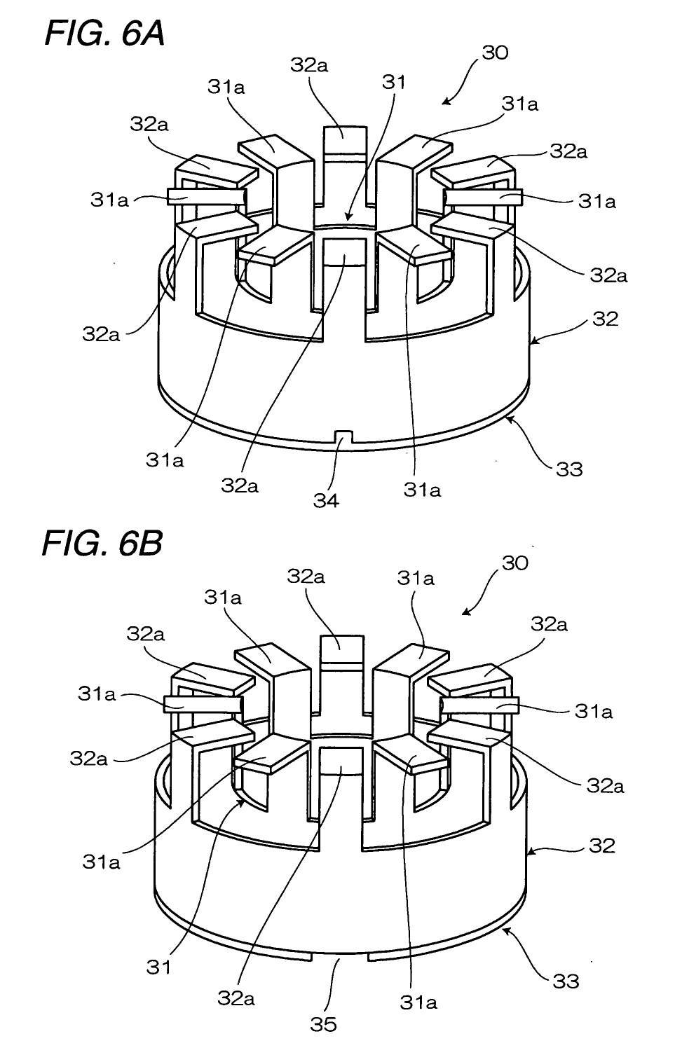

FIGS. 6A-6B are perspective views of a yoke in the faucet generator shown in FIG. 3.

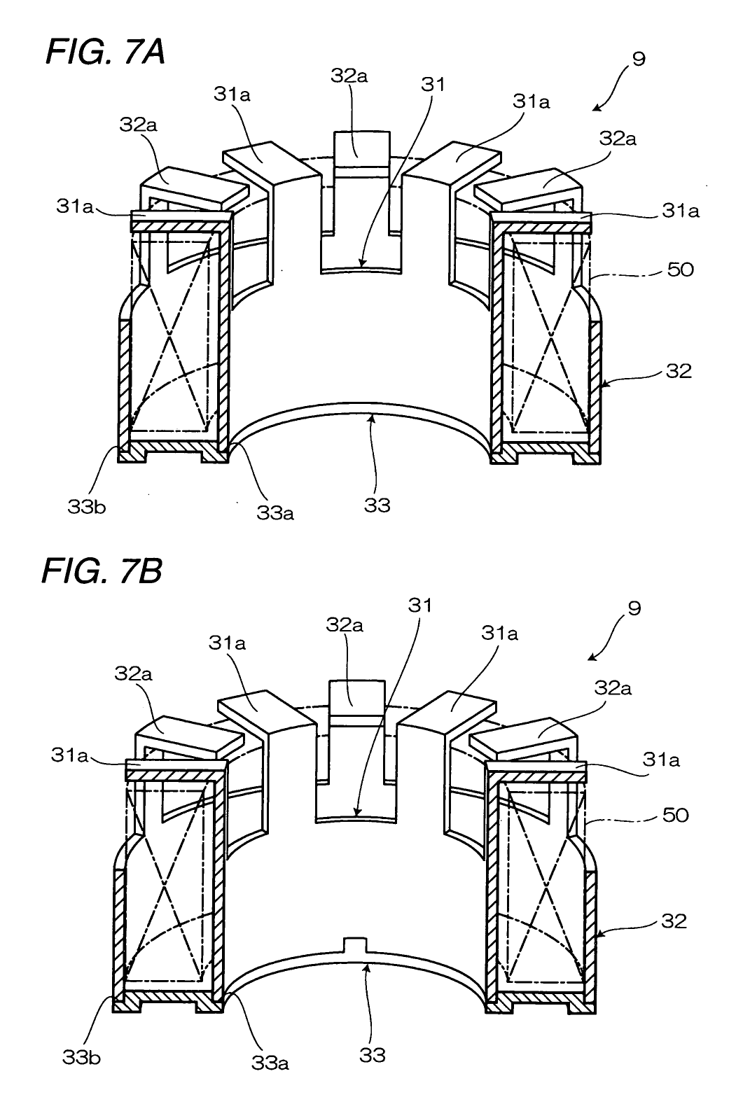

FIGS. 7A-7B are central sectional perspective views of the yoke shown in FIGS. 6A-6B.

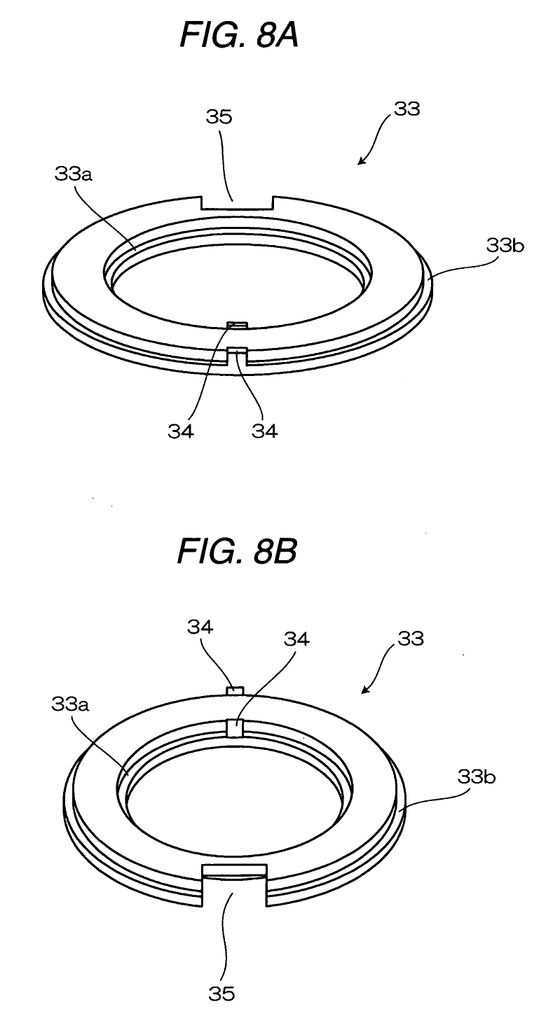

FIGS. 8A-8B are perspective views of a third yoke in the yoke shown in FIGS. 6A-6B.

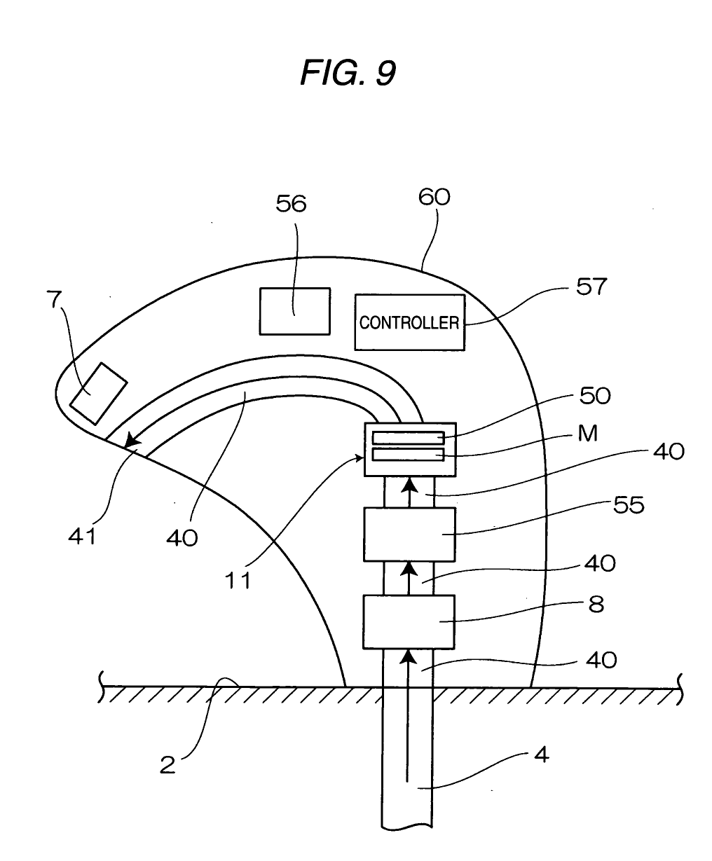

FIG. 9 is a schematic view showing the internal configuration of a faucet apparatus of a second embodiment.

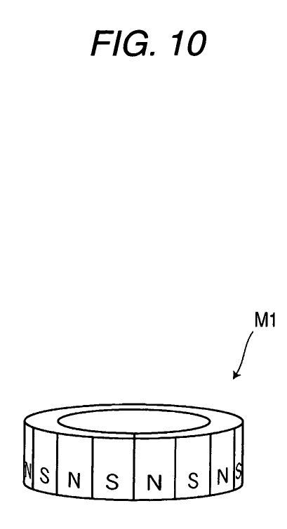

FIG. 10 is a schematic perspective view of a magnet in a faucet generator in a modification.

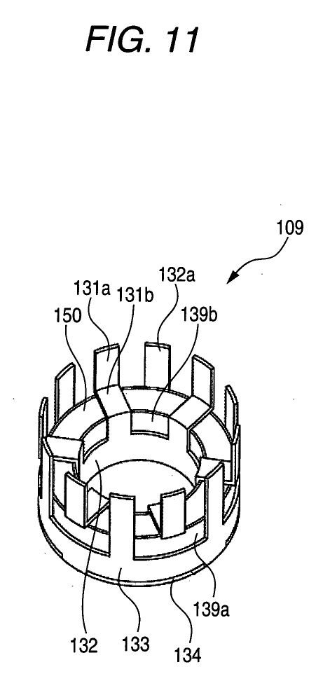

FIG. 11 is a schematic perspective view of a stator in the faucet generator in the modification.

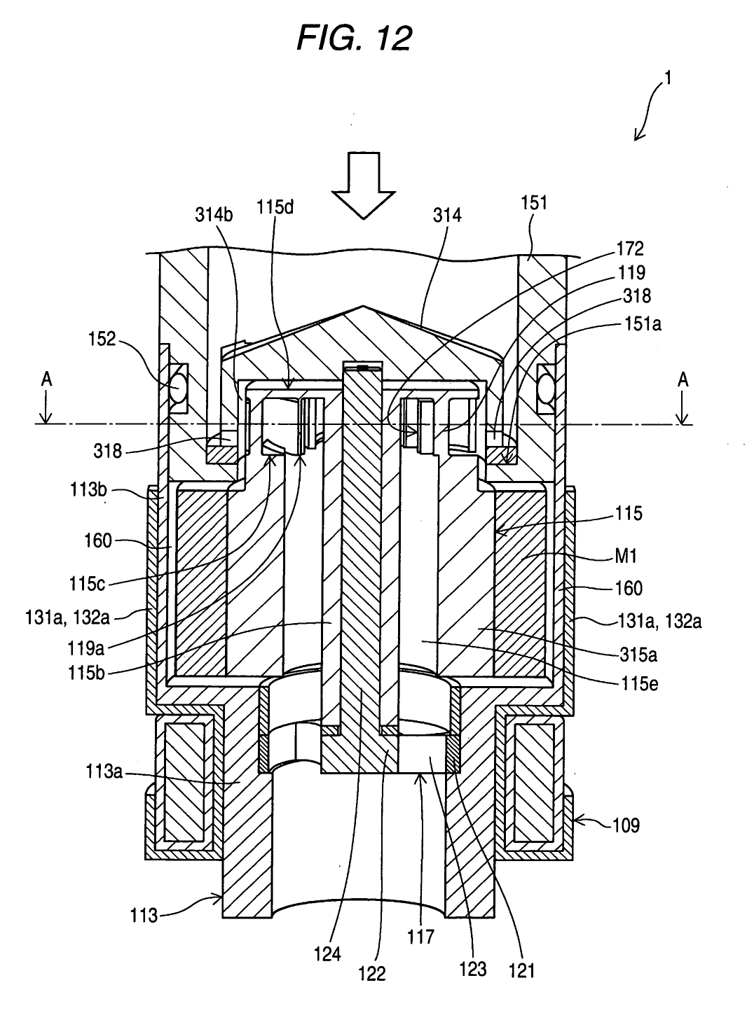

FIG. 12 is a schematic sectional view of the faucet generator in the modification.

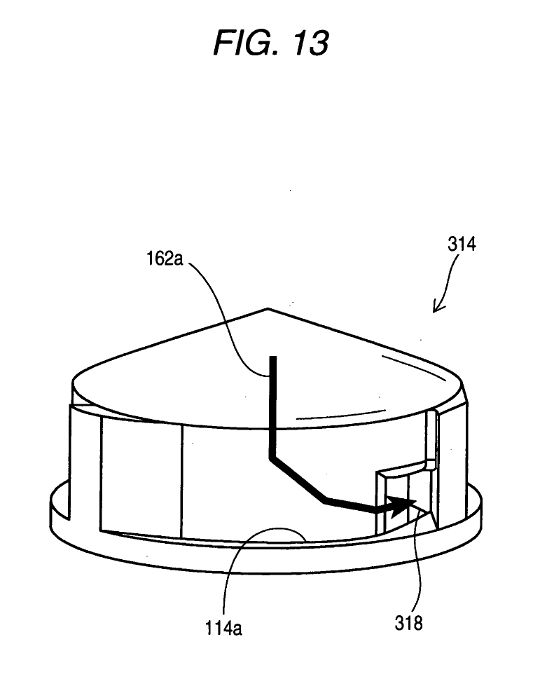

FIG. 13 is a schematic perspective view of a cap in the faucet generator in the modification.

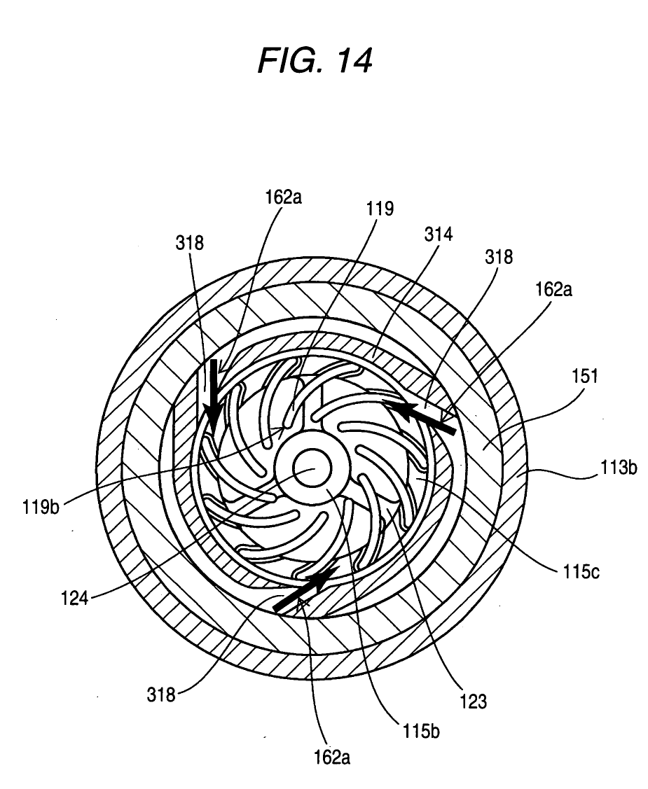

FIG. 14 is a sectional view looking in the direction of the arrows A-A in FIG. 12.

### DETAILED DESCRIPTION

Hereinafter, embodiments of the invention will be described with reference to the drawings. In the drawings, identical components are denoted by the same reference numerals.

FIG. 1 is a schematic view showing the internal configuration of a faucet apparatus 3 of a first embodiment.

FIG. 2 is a schematic view showing an appearance of the faucet apparatus of the first embodiment and an example of mounting.

The faucet apparatus 3 of the first embodiment is mounted in, for example, a washstand 2. The faucet apparatus 3 is connected to a water inflow port 5 for tap water or the like, through a piping 4. The faucet apparatus 3 has a cylindrical body 3a, and a water discharger 3b. The water discharger 3b is disposed in an upper portion of the body 3a while extending in a radially outward direction of the body 3a. A water discharging port 6 is formed at the tip end of the water discharger 3b, and a sensor 7 is incorporated in the vicinity of the water discharging port 6.

A water supply channel 10 which guides water that inflows from the water inflow port 5 and flows through the piping 4, to the water discharging port 6 is formed inside the faucet apparatus 3. The body 3a incorporates a solenoid valve 8 which opens and closes the water supply channel 10, and, on the downstream side of the solenoid valve 8, a constant flow valve 55 which restricts the amount of water discharge to a constant value. A reducing valve or regulating valve (not shown) which reduces the water supply pressure in the case where the water supply pressure of tap water is higher than the use pressure is incorporated in the upstream side of the solenoid valve 8. The constant flow valve 55, the reducing valve, and the regulating valve may be adequately disposed as required.

A faucet generator (hereinafter, often referred to simply as generator) 11 is disposed inside the water discharger 3b, and on the downstream side of the constant flow valve 55.

FIG. 3 is a schematic sectional view showing the interior of the faucet generator 11 in the first embodiment.

FIG. 4 is a perspective view of a pre-rotation stator vane 14, a rotor vane 15, and a bearing 17 in the faucet generator 11 shown in FIG. 3.

FIG. 5 is a perspective view of a magnet M in the faucet generator 11 shown in FIG. 3.

FIG. 6A is a perspective view of a yoke 30 in the faucet generator 11 shown in FIG. 3, and FIG. 6B is a perspective view as viewed from the opposite side of FIG. 6A.

FIG. 7A is a central sectional perspective view of the yoke 30, and FIG. 7B is a central sectional perspective view as viewed from the opposite side of FIG. 7A.

FIG. 8A is a perspective view of a third yoke 33 in the yoke 30, and FIG. 8B is a perspective view as viewed from the opposite side of FIG. 8A.

As shown in FIG. 3, the faucet generator in the first embodiment mainly includes a cylindrical body 13, the pre-rotation stator vane 14, the rotor vane 15, the magnet M, and a stator 9. These components are housed in a case 12 shown in FIG. 1.

The cylindrical body 13 has a stepped shape consisting of a small-diameter portion 13a and a large-diameter portion 13b. The cylindrical body 13 is disposed in the water discharger 3b which is shown in FIGS. 1 and 2, in a state where the interior of the cylindrical body 13 communicates with the water supply channel. The cylindrical body 13 is disposed so that the center axis direction is substantially parallel to the direction of the water flow. The cylindrical body 13 is disposed in such a manner that the small-diameter portion 13a is directed toward the upstream side, and the large-diameter portion 13b is directed toward the downstream side.

In the cylindrical body 13, in the sequence starting from the upstream side, the pre-rotation stator vane 14, the rotor vane 15, and the bearing 17 are disposed. The pre-rotation stator vane 14 is disposed inside the small-diameter portion 13a, and the rotor vane 15 and the bearing 17 are disposed inside the large-diameter portion 13b. The opening at the downstream end of the large-diameter portion 13b is liquid-tightly closed by a sealing member 51 through an O-ring 52. A stepped hole is disposed inside the sealing member 51. A step portion 51a of the member is annularly formed, and the bearing 17 is supported on the step portion 51a.

The pre-rotation stator vane 14 has a shape in which a conical member is disposed integrally on one end face (the face positioned on the upstream side) of a columnar member. A plurality of projective stator vane blades 18 which are projected in a radially outward direction are disposed on the circumferential face of the pre-rotation stator vane 14. As shown in FIG. 4, the stator vane blades 18 are inclined from the upstream side toward the downstream side while being twisted in the rightward direction about the axis center of the pre-rotation stator vane 14. Each space which is between the stator vane blades 18 that are adjacent to each other in the circumferential direction functions as a stator vane channel 71. The pre-rotation stator vane 14 is fixed to the cylindrical body 13, and is not rotated.

The rotor vane 15 is disposed on the downstream side of the pre-rotation stator vane 14 while forming a gap with respect to the pre-rotation stator vane 14. The rotor vane 15 has a columnar shape, and a plurality of projective rotor vane blades 19 which are projected in a radially outward direction are disposed on the circumferential face of the rotor vane 15. As shown in FIG. 4, contrary to the stator vane blades 18, the rotor vane blades 19 are inclined from the upstream side toward the downstream side while being twisted in the leftward direction about the axis center. Each space which is between adjacent ones of the rotor vane blades 19 that are adjacent to each other in the circumferential direction functions as a rotor vane channel 72. The rotor vane 15 is supported on the bearing 17 fixed to the cylindrical body 13 through a center shaft 24 which is substantially parallel to the water supply channel. The rotor vane 15 is rotatable together with the center shaft 24 integrated therewith.

The bearing 17 is configured by coupling a ring member 21 which is fixed to the inner circumferential face of the cylindrical body 13 with a shaft supporting portion 22 which is disposed at the center of the ring member 21, by coupling members 23 which are radiately disposed. The gaps between the coupling members 23 are not closed and are passed through the bearing, and hence the water flow inside the cylindrical body 13 is not disturbed.

The center shaft 24 which is fixed to the axis center of the rotor vane 15 is rotatably supported on the shaft supporting portion 22 of the bearing 17. A tip end portion of the center shaft 24 is projected from the rotor vane 15, and fitted into the pre-rotation stator vane 14. The tip end portion of the center shaft 24 and the pre-rotation stator vane 14 are not fixed to each other, and the center shaft 24 is rotatable with respect to the pre-rotation stator vane 14 fixed to the cylindrical body 13. Alternatively, a configuration may be formed in which the both end portions of the center shaft 24 are fixed to the shaft supporting portion 22 and the pre-rotation stator vane 14, respectively, and the rotor vane 15 is rotatably fitted to the center shaft 24. Namely, the rotor vane 15 having the rotor vane blades may be disposed in the water supply channel so that the axial direction of the rotor vane 15 is substantially parallel to the water supply channel. Here, the axial direction of the rotor vane 15 is identical with the direction of the center shaft 24.

The cylindrical magnet M which is fixed to the rotor vane blades 19 so as to surround the rotor vane channels 72 is housed in the large-diameter portion 13b of the cylindrical body 13. The inner circumferential face of the magnet M which is indicated by the dash-dot-dot line in FIG. 4 is fixed to radially outward side end faces of the rotor vane blades 19.

As shown in FIG. 5, the end face in the axial direction of the magnet M is alternately magnetized with N and S poles along the circumferential direction.

Outside the large-diameter portion 13b of the cylindrical body 13 in the axial direction, the stator 9 is disposed to be opposed to the upstream end face of the magnet M. The stator 9 is configured by the yoke 30 (FIG. 6) and a coil 50 (indicated by the dash-dot line in FIG. 7) housed in a space surrounded by the yoke 30. In the coil 50 which is wound in a cylindrical shape, the inner and outer circumferential faces and the end faces in the axial direction are surrounded by the yoke 30. The yoke 30 is configured by coupling together first to third yokes 31 to 33 all of which are formed by a magnetic material.

The first yoke 31 has a substantially cylindrical shape which is placed inside the coil 50. A plurality of pole teeth 31a are integrally disposed toward the radially outer side, in one axial direction end portion of the first yoke 31. In the first yoke 31, a portion which is opposed to the inner circumferential face of the coil 50 is substantially perpendicular to the pole teeth 31a. The pole teeth 31a are placed at regular intervals along the circumferential direction of the coil 50.

The second yoke 32 has a substantially cylindrical shape which is placed so as to surround the outer circumferential face portion of the coil 50. A plurality of pole teeth 32a are integrally disposed toward the radially inner side, in one axial direction end portion of the second yoke 32. In the second yoke 32, a portion which is opposed to the outer circumferential face of the coil 50 is substantially perpendicular to the pole teeth 32a. The pole teeth 32a are placed at regular intervals along the circumferential direction of the coil 50, and between the pole teeth 31a of the first yoke 31. Namely, the pole teeth 31a of the first yoke 31, and the pole teeth 32a of the second yoke 32 are arranged alternately and separately in the circumferential direction of the coil 50.

The pole teeth 31a, 32a are opposed to one end face of the coil 50. The one end face of the coil 50 is opposed to the upstream end face of the magnet M across the pole teeth 31a, 32a and a flange portion 13c of the cylindrical body 13.

The third yoke 33 has a ring plate-like shape which is disposed to be opposed to the other end face of the coil 50. An inner-circumference step portion 33a is annularly formed in the inner circumferential side of the third yoke 33. An outer-circumference step portion 33b is annularly formed in the outer circumferential side of the third yoke 33. Convex-like positioning portions 34 are disposed in each of the inner-circumference step-portion 33a and the outer-circumference step portion 33b. A part of the outer circumferential side of the third yoke 33 is cut away to form a coil wiring takeout portion 35.

The third yoke 33 is coupled to end portions of the first yoke 31 and the second yoke 32 which are opposite to the end portions where the respective pole teeth 31a, 32a are disposed. Specifically, an end portion (in FIGS. 6 and 7, the lower end) of the first yoke 31 is engaged with the inner-circumference step portion 33a of the third yoke 33. An end portion (in FIGS. 6 and 7, the lower end) of the second yoke 32 is engaged with the outer-circumference step portion 33b of the third yoke 33. The coil 50 is housed in a space surrounded by the first to third yokes 31 to 33, and drawn out through the coil wiring takeout portion 35 which is formed in the outer circumferential side of the third yoke 33.

The positioning portions 34 which have, for example, a convex-like shape are disposed in the third yoke 33. When the positioning portions 34 are engaged with concave-like cutaway portions formed in the first yoke 31 and the second yoke 32, the first yoke 31 and the second yoke 32 are positioned in the circumferential direction, respectively. According to the configuration, a predetermined pitch between the pole teeth 31a, 32a can be accurately ensured. Alternatively, convex-like positioning portions may be disposed in the third yoke 33, and convex-like positioning portions may be disposed in the first yoke 31 and the second yoke 32, respectively.

As shown in FIG. 1, the faucet generator 11 is disposed downstream from the solenoid valve 8 and the constant flow valve 55, and hence the water supply pressure (primary pressure) of the tap water does not directly act on the generator 11. Therefore, the faucet generator 11 is not requested to have a high pressure tightness, and this arrangement is advantageous in reliability and cost.

A battery 56 which stores the power generated by the faucet generator 11, and a controller 57 which controls the driving of the sensor 7 and the opening and closing operations of the solenoid valve 8 are disposed inside the body 3a of the faucet apparatus 3. The battery 56 and the controller 57 are placed at positions which are in an upper portion of the body 3a and above the highest position of the water supply channel 10.

In the generator 11 incorporated in the water discharger 3b, the coil 50 is placed while being opposed to the upstream end face of the magnet M. The magnet M is positioned on the side of the water discharging port 6 as viewed from the coil 50. When viewed from the magnet M, the coil 50 is positioned not on the side of the water discharging port 6, but on the side of the body 3a. When viewed from the controller 57, the coil 50 is positioned in front of the magnet M, and the magnet M is not positioned between the controller 57 and the coil 50. The coil 50 and the controller 57 are connected to each other through wiring which is not shown, so that the controller 57 receives the output of the coil 50.

In the faucet apparatus 3 and generator 11 which are configured as described above, when the user introduces a hand under the water discharging port 6, the introduction is sensed by the sensor 7, and the solenoid valve 8 is opened by the controller 57. This causes the water flow to be supplied into the cylindrical body 13 of the faucet generator 11, and the water flows inside the cylindrical body 13 to be discharged from the water discharging port 6. When the user removes the hand from the area under the water discharging port 6, the solenoid valve 8 is closed to automatically stop the water flow.

The water flow flowing into the cylindrical body 13 flows over the surface of the conical member of the pre-rotation stator vane 14 to spread radially outward, and, in the specific example, is formed as a swirling flow which swirls in the rightward direction about the axis center, to flow through the stator vane channels 71 between the stator vane blades 18.

The swirling flow which has flown through the stator vane channels 71 enters the rotor vane channels 72, and impinges on the upper inclined faces of the rotor vane blades 19. In the specific example, the swirling flow entering the rotor vane channels 72 is a flow which swirls in the rightward direction about the axis center, and hence a rightward force acts on the rotor vane blades 19, so that the rotor vane 15 is rotated in the rightward direction. The water flow which flows through the rotor vane channels 72 that are inside the inner circumferential face of the magnet M passes through the inside of the bearing 17, and then passes through the inside of the cylindrical body 13 to reach the water discharging port 6.

When the rotor vane 15 is rotated, also the magnet M fixed to the rotor vane is rotated. As described above, the end face of the magnet M is alternately magnetized with N and S poles along the circumferential direction (rotation direction). When the magnet M is rotated, therefore, the polarities of the pole teeth 31a, 32a which are opposed to the end face of the magnet M, and those of the first and second yokes 31, 32 which are integrated with the pole teeth are changed. As a result, the directions of interlinking magnetic fluxes with respect to the coil 50 are changed, and an electromotive force is produced in the coil 50, thereby performing electricity generation. The generated power is sent to the battery 56 to be stored thereinto, and then used in the driving of, for example, the solenoid valve 8, the sensor 7, and the controller 57.

In the embodiment, the coil 50 and the controller 57 are placed on the same side with respect to the magnet M (in the embodiment, for example, on the side of the upstream end face of the magnet M). Therefore, the wiring for taking out the output of the coil 50 is not required to be laid to the controller 57 beyond the magnet M, and the wiring distance between the coil 50 and the controller 57 can be shortened, thereby facilitating the assembling work.

Furthermore, the coil 50 is drawn out from the outer circumferential side of the coil 50 to the outside through the coil wiring takeout portion 35 which is formed in the outer circumferential side of the third yoke 33. Therefore, the wiring to the controller 57 is laid easily as compared with the case where the wiring is drawn out from the inner circumferential side of the coil 50.

Furthermore, the space where the drawn out wiring from the coil 50 is passed is largely ensured outside the magnet M, and hence it is not necessary to decrease the diameter of the magnet M or to increase the flange portion 13a of the cylindrical body 13 in which the magnet M is housed. Therefore, it is possible to provide a compact generator while ensuring a desired generated electricity amount.

In the first embodiment, the controller 57 is placed above the highest position of the water supply channel 10. Even when a water drop due to condensation on the outer face of a channel piping forming the water supply channel 10 falls or flows down along the channel piping, therefore, it is possible to prevent the controller 57 from being submerged, and also a failure of the controller 57 from occurring. Similarly, also the battery 56 is disposed above the water supply channel 10. Therefore, it is possible to prevent the battery 56 from being submerged, and also a failure of the battery 56 from occurring.

Moreover, the first embodiment has the structure where the stator 9 is opposed in the axial direction of the magnet M. Therefore, the radial dimension can be reduced as compared with the case where the stator 9 is opposed in a radially outward direction of the magnet M. Furthermore, the generator 11 is a so-called axial generator in which the rotor vane 15 is disposed so that the rotation shaft 24 is substantially parallel of the direction the water flow, the magnet M is disposed radially outside the rotor vane 15, while the rotation center of the magnet coincides with that of the rotor vane 15, and the rotor vane 15 is rotated by the force of the water flow flowing inside the magnet M. Therefore, the radial dimension can be reduced as compared with a water wheel structure where an impeller is placed while the rotation shaft is set to be substantially perpendicular to the direction of the water flow, and a magnet which is coupled to the rotation shaft of the impeller to be rotated together therewith, and a coil which is opposed to the outer circumferential face of the magnet are projected to the outside of a channel. As described above, the structure of the embodiment is advantageous in reduction of the radial dimension of the generator. Even when the generator is incorporated in the cylindrical water discharger 3b, therefore, the slender and simple design of the water discharger 3b is not impaired. The radial dimension of the rotor vane 15 can be increased by a degree corresponding to the configuration where the stator 9 is not placed radially outside the rotor vane 15, and hence the power generation efficiency can be improved.

FIG. 9 is a schematic view showing the internal configuration of a faucet apparatus of a second embodiment.

The faucet apparatus of the second embodiment is different in design of the case body from the above-described first embodiment. Unlike the first embodiment, the body and the water discharger are not distinctly distinguished from each other, and a water discharging port 41 is directly disposed on the curved body 60. In the body 60, a water supply channel 40 is disposed, and the solenoid valve 8, the constant flow valve 55, and the generator 11 are disposed in the sequence starting from the upstream side of the water supply channel 40.

Also in the second embodiment, the coil 50 and the controller 57 are placed on the same side with respect to the magnet M (in the embodiment, for example, on the side of the downstream end face of the magnet M). Therefore, the wiring for taking out the output of the coil 50 is not required to be laid to the controller 57, beyond the magnet M, and the wiring distance between the coil 50 and the controller 57 can be shortened, thereby facilitating the assembling work.

Furthermore, the battery 56 and the controller 57 are placed in an upper portion of the body 60 and above the water supply channel 40. Even when a water drop due to condensation on the outer face of a channel piping forming the water supply channel 40 falls or flows down along the channel piping, therefore, it is possible to prevent the battery 56 and the controller 57 from being submerged, and also a failure of the battery 56 and the controller 57 from occurring.

In the first and second embodiments, the controller 57 is disposed above a joint of the water supply channel 10 or 40. Even when water leaks from the joint, therefore, it is possible to prevent the controller 57 from being submerged. The joint of the water supply channel 10 or 40 means joints between the water supply channel 10 or 40 and the faucet generator 11 in, for example, FIG. 1 or 9.

The faucet apparatus of the invention is preferably used in a living environment. Examples of the purpose of use are a kitchen faucet apparatus, a living-dining faucet apparatus, a shower faucet apparatus, a bathroom faucet apparatus, and a lavatory faucet apparatus. The application of the generator is not restricted to an automatic faucet apparatus using a human body detecting sensor. For example, the generator may be applied also to a one-touch faucet apparatus which is operated by on/off operations of a manual switch, a constant volume discharging faucet apparatus which counts the flow amount to stop the water flow, a timer faucet apparatus which, when a preset time elapses, stops the water flow, and the like. The generated electric power may be used in, for example, lighting up, production of electrolyzed functional water such as ionized alkaline water or water containing silver ions, display (measurement) of the flow amount, display of a temperature, and voice guidance.

In the faucet apparatus of the invention, for example, the discharge flow amount is set to 100 liters or less per minute, or preferably 30 liters or less per minute. In a lavatory faucet, particularly, the discharge flow amount is preferably set to 5 liters or less per minute. In the case where the discharge flow amount is relatively large, such as a bathroom faucet, it is preferable that the water flow flowing from a water supply pipe to the generator 11 is branched to adjust the amount of the flow flowing through the generator 11 to 30 liters or less per minute. This is because, when the whole of the water flow is supplied to the generator 11, the rotation number of the rotor vane 15 is excessively increased, and there is a fear that noises or shaft wear is increased. When, although the rotation number is increased, the rotation number is not an adequate one or lower, an energy loss is caused by an eddy current or heat in the coil, and hence the generated electricity amount is not increased. In Japan, for example, the water pressure of a water pipe to which the faucet apparatus is mounted may be sometimes as low as about 0.05 (MPa).

Next, a faucet generator of a modification having a stator in which pole teeth are disposed radially outside of a magnet, and a coil is disposed so as to be opposed to an end face of the magnet that is substantially perpendicular to the radial direction will be described.

First, a magnet M1 and a stator 109 will be described.

FIG. 10 is a schematic perspective view illustrating the magnet M1.

FIG. 11 is a schematic perspective view illustrating the stator 109.

As shown in FIG. 10, the end face (outer circumferential face) in the radial direction of the magnet M1 is alternately magnetized in the side face with N and S poles along the circumferential direction.

The stator 109 has: a coil 150 which is disposed so as to be opposed to the end face of the magnet M1 that is substantially perpendicular to the radial direction; a plurality of pole teeth 131a, 132a which are arranged alternately and separately in the circumferential direction of the side face of the magnet M1; and yokes 131b, 132, 133, 134 which are continuously contacted with the pole teeth 131a, 132a, and which are made of magnetic materials that are disposed so as to surround the coil 150.

In the coil 150 which is wound in a cylindrical shape, the inner and outer circumferential faces and the end faces in the axial direction are surrounded by the yokes 131b, 132, 133, 134. All of the pole teeth 131a, 132a and the yokes 131b, 132, 133, 134 are formed by a magnetic material.

The first yoke 132 has a substantially cylindrical shape, and is placed so as to surround the inner circumferential face of the coil 150. The plurality of yokes 131b are integrally disposed toward the radially outer side, in one axial direction end portion of the first yoke 132. In the first yoke 132, a portion which is opposed to the inner circumferential face of the coil 150 is substantially perpendicular to the yokes 131b. The yokes 131b are placed at regular intervals along the circumferential direction of the coil 150. One ends of the yokes 131b further extend in the axial direction of the coil 150 to form the pole teeth 131a.

The second yoke 133 has a substantially cylindrical shape, and is placed so as to surround the outer circumferential face portion of the coil 150. The plurality of pole teeth 132a are integrally disposed in the axial direction, in one axial direction end portion of the second yoke 133.

The pole teeth 132a are placed at regular intervals along the circumferential direction of the coil 150, and between the pole teeth 131a. Namely, the pole teeth 131a and the pole teeth 132a are arranged alternately and separately in the circumferential direction of the coil 150.

The pole teeth 131a and the pole teeth 132a are disposed immediately above a portion (the second yoke 133) which is placed so as to surround the outer circumferential face of the coil 150. The distances from the center of the coil 150 to the pole teeth 131a and the pole teeth 132a are approximately equal to each other.

The pole teeth 131a, 132a are disposed so as to extend in the axial direction from the outer circumferential face of the coil 150. The inner circumferential faces (the faces on the side located in the center direction of the coil 150) of the pole teeth are opposed to the outer circumferential face (the face in a radially direction) of the magnet M1.

The yokes 131b are opposed to one end face of the coil 150. The one end face of the coil 150 is opposed to the axial end face of the magnet M1 across the yokes 131b and a flange portion of a cylindrical body 113.

The third yoke 134 has a ring plate-like shape, and is disposed to be opposed to the other end face of the coil 150. A part of the outer circumferential side of the third yoke 134 is cut away so that a coil wiring takeout portion which is not shown is formed.

The third yoke 134 is coupled to end portions of the first yoke 132 and the second yoke 133 which are opposite to the end portions where the respective pole teeth 131a, the yoke 131b, and the pole teeth 132a are disposed. The coil 150 is housed in a space surrounded by the first yoke 132, the second yoke 133, and the third yoke 134. Wiring from the coil 150 is drawn out from the coil wiring takeout portion which is formed in the outer circumferential side of the third yoke 134, and which is not shown, to the outside. As compared with the case where the wiring is drawn out from the inner circumferential side, therefore, the wiring to the controller 57 is laid easily.

For example, convex-like positioning portions which are not shown are disposed in the third yoke 134. When the positioning portions are engaged with concave-like cutaway portions formed in the first yoke 132 and the second yoke 133, the first yoke 132 and the second yoke 133 are positioned at predetermined positions in the circumferential direction, respectively. According to the configuration, the pitch accuracy between the pole teeth 131a, 132a can be improved. Alternatively, concave-like cutaway portions may be disposed in the third yoke 134, and convex-like positioning portions may be disposed in the first yoke 132 and the second yoke 133.

Cutaway portions 139a are disposed in the second yoke 133, and cutaway portions 139b are disposed in the third yoke 134. In this way, in the first yoke 132 and the second yoke 133, the cutaway portions 139a, 139b which are formed by cutting away portions between adjacent pole teeth from the one end sides where the pole teeth 131a, 132a are disposed are intermittently disposed in the portion which is disposed so as to surround the circumferential face portion of the coil 150, whereby the first yoke 132 and the second yoke 133 are magnetically insulated from each other in the circumferential direction. In the magnetic path which is formed along the circumferential faces of the first yoke 132 and the second yoke 133, portions which are not required for electricity generation are cut away, so that the iron loss can be suppressed and the generated electricity amount can be increased.

When, in the yokes, the cutaway portions which are formed by cutting away portions between adjacent the pole teeth from one end side where the pole teeth are disposed are intermittently disposed in a direction that is substantially perpendicular to a radial direction as described above, the portions of the yokes where the pole teeth are disposed are relatively separated from the magnetically inducible area of the magnet.

Next, the faucet generator 1 of the modification will be described with reference to FIG. 12.

The cylindrical body 113 has a stepped shape consisting of a small-diameter portion 113a and a large-diameter portion 113b. The cylindrical body 113 is disposed in the water discharger 3b which is shown in FIGS. 2 and 3, in a state where the interior of the cylindrical body 113 communicates with the water supply channel. In this case, the cylindrical body is disposed in such a manner that the center axis direction of the cylindrical body 113 (a rotor vane 115) is substantially parallel to the direction of the water flow. The cylindrical body 113 is disposed while the small-diameter portion 113a is directed toward the downstream side, and the large-diameter portion 113b is directed toward the upstream side.

In the cylindrical body 113, in the sequence starting from the upstream side, a cap 314, the rotor vane 115, and a bearing 117 are disposed. The bearing 117 is disposed inside the small-diameter portion 113a, and the cap 314 and the rotor vane 115 are disposed inside the large-diameter portion 113b.

The opening at the upstream end of the large-diameter portion 113b is liquid-tightly closed by a sealing member 151 through an O-ring 152. A stepped hole is disposed inside the sealing member 151. A step portion 151a of the member is annularly formed, and the cap 314 is supported on the step portion 151a. The cap 314 is fixed to the cylindrical body 113, and is not rotated.

The rotor vane 115 is disposed on the downstream side of the cap 314. The rotor vane 115 has a columnar shape, and a plurality of projective rotor vane blades 119 which are projected in a radially inward direction are disposed. Each space which is between adjacent ones of the rotor vane blades 119 that are adjacent to each other in the circumferential direction functions as a rotor vane channel 172.

A gap which enables the rotor vane 115 to be rotatable is disposed between an end face of a rotor vane integral rotary member 315a which will be described later and the magnet M1, and the cylindrical body 113 and the sealing member 151. The gap functions as a bypass channel 160.

A center shaft 124 which is integrated with the bearing 117 is disposed so as to be projected toward the upstream side. The center shaft 124 is passed through a boss portion 115b of the rotor vane 115 so that the rotor vane 115 is rotatable about the center shaft 124. Alternatively, the rotor vane 115 and the center shaft 124 may be integrated with each other, and both end portions of the center shaft 124 may be supported by the cap 314 and the bearing 117, so that the rotor vane 115 which is integrated with the center shaft 124 is rotated. Namely, the rotor vane 115 having the rotor vane blades may be disposed in the water supply channel so that the axial direction of the rotor vane 115 is substantially parallel to the water supply channel. Here, the axial direction of the rotor vane 115 is identical with the direction of the center shaft 124.

The bearing 117 includes: a ring member 121 which is fixed to the inner circumferential face of the cylindrical body 113; and a shaft supporting portion 122 which is disposed at the center of the ring member 121. The ring member 121 and the shaft supporting portion 122 are coupled to each other by coupling members 123 which are radiately disposed. The gaps between the coupling members 123 are not closed, and are passed through the bearing. Therefore, the water flow inside the cylindrical body 113 is not disturbed.

The rotor vane integral rotary member 315a which is disposed downstream from the rotor vane blades 119, and on the side end face on the radially outer side, and the annular magnet M1 which is fixed to an outer circumferential portion of the rotor vane integral rotary member 315a are housed in the large-diameter portion 113b of the cylindrical body 113. Outside the small-diameter portion 113a of the cylindrical body 113, the stator 109 is disposed so as to be opposed to an end face of the magnet M1 which is on the downstream side, and which is substantially perpendicular to a radial direction.

FIG. 13 is a schematic perspective view illustrating the cap 314 dispose in the generator 1 in the modification.

FIG. 14 is a sectional view of the generator 1 in the modification.

As shown in FIGS. 13 and 14, the cap 314 has a shape in which a conical member is disposed integrally on one end face (the face positioned on the upstream side) of a columnar member. A flange portion 114a is disposed on the other end face (the face positioned on the downstream side) of the columnar member.

A space portion 314b having a columnar shape which is opened in the end face where the flange portion is formed is disposed in the cap 314. The rotor vane blades 119 which are disposed on the side of the upstream end of the rotor vane 115 are housed in the space portion 314b. One end of the center shaft 124 which is passed through the rotor vane 115 is supported on the center axis of the cap 314, and on the face of the cap facing to the space portion 314b.

Three nozzles 318 which communicate with the space portion 314b are disposed in the circumferential face of the cap 314. The nozzles 318 are disposed at regular intervals along the circumferential direction of the circumferential face of the cap so that the lower faces of the nozzles are in contact with the upper face of the flange portion. The nozzles 318 are opened toward the rotor vane blades 119 housed in the space portion 314b, and the directions of the nozzles are oriented toward the inner side with respect to the tangential direction of the circumscribed circle of the rotor vane blades 119.

According to the nozzles 318, water which flows in a direction parallel to the rotation center (center shaft) can be ejected from the radially outward direction of the rotor vane blades 119 toward the rotor vane blades 119, in a plane which is substantially perpendicular to the rotation center (center shaft).

The direction of the water ejected from the nozzles 318 is oriented toward the inner side with respect to the tangential direction of the circumscribed circle of the rotor vane blades 119.

The upstream end faces of the rotor vane blades 119 are supported by a ceiling portion 115d of the rotor vane 115, and the downstream end faces 119a are supported by a blade supporting face 115c of the rotor vane 115. In the radially outward end face (outer circumferential face) of the rotor vane 115, therefore, the rotor vane blades 119 are not supported, and water can flow from the radially outward end face (outer circumferential face) of the rotor vane 115 toward the inner side.

As shown in FIG. 14, the rotor vane blades 119 are configured by curves, and curved in a direction along which the tip ends approach the center of the rotor vane 115. Outlet ends 119b of the rotor vane blades 119 are separated from the boss portion 115b of the rotor vane 115, and the rotor vane blades are configured so that smooth water flows along the rotor vane blades 119 are formed from the inlet sides of the rotor vane blades 119 toward the outlet sides. Therefore, the impeller efficiency can be improved, and hydro energy can be efficiently converted to electric power.

The number of the rotor vane blades 119 is not equal to an integer multiple of the number of the nozzles 318. For example, the number of the rotor vane blades 119 is eleven, and that of the nozzles 318 is three. When the number of the rotor vane blades 119 is different from an integer multiple of the number of the nozzles 318, the timings of ejections to the rotor vane blades 119 can be staggered, and hence it is possible to prevent the rotor vane 115 from generating vibrations and noises.

The outlet ends 119b of the rotor vane blades 119 are disposed so as to be projected toward the inside of the rotor vane 115 with respect to the blade supporting face 115c supporting the downstream end faces of the rotor vane blades 119. Therefore, the radial dimension of water channels 115e which are disposed inside the blade supporting face 115c can be increased, and hence the pressure loss can be suppressed. Furthermore, the radial length of the rotor vane blades 119 can be increased, so that the area of the rotor vane blades 119 can be increased. As a result, the impeller efficiency can be improved, and hydro energy can be efficiently converted to electric power.

The downstream end faces 119a of the rotor vane blades 119 are positioned downstream from the nozzles 318. Among the water flows ejected from the nozzles 318, therefore, also those which spread toward the downstream side can be caused to impinge on the rotor vane blades 119, with the result that the impeller efficiency can be improved, and hydro energy can be efficiently converted to electric power.

As shown in FIG. 13, according to the nozzles 318, a water flow 162a which flows in a direction parallel to the center shaft 124 can be ejected from the radially outward direction of the rotor vane 115 (rotor vane blades 119) toward the inner side, in a plane which is substantially perpendicular to the center shaft 124.

Although the invention has been described in detail and with reference to specific embodiments, it is obvious to those skilled in the art that various changes and modifications can be made without departing from the spirit and scope of the invention.

What is claimed is:

1. A faucet apparatus comprising:
a rotatable rotor vane which is disposed in a water supply channel, and in which an axial direction is substantially parallel to said water supply channel;
a magnet which is rotatable integrally with said rotor vane;
a coil which is disposed to be opposed to one end face in an axial direction of said magnet; and
a controller which is disposed on a side of said one end face of said magnet and above said water supply channel, and which is connected to said coil through wiring.

2. The faucet apparatus according to claim 1, wherein said magnet has a cylindrical shape which surrounds said rotor vane.

3. The faucet apparatus according to claim 1, wherein said coil is drawn out from an outer circumferential side of said coil to be connected to said wiring.

4. The faucet apparatus according to claim 2, wherein said coil is drawn out from an outer circumferential side of said coil to be connected to said wiring.
